(19) United States
(12) Patent Application Publication
(10) Pub. No.: US 2007/0248448 A1
(43) Pub. Date: Oct. 25, 2007

(54) Apparatus and process for the automatic palletising and/or depalletising of containers

(76) Inventor: Reiner Starz, Weil der Stadt (DE)

Correspondence Address: FACTOR & LAKE, LTD., Suite 5G/H, 1327 W. Washington Blvd., Chicago, IL, 60607, US

(21) Appl. No.: 11/786,893

(22) Filed: Apr. 12, 2007

(30) Foreign Application Priority Data
Apr. 21, 2006 (DE) 102006018502.1

(51) Int. Cl. B65G 57/00

(52) U.S. Cl. 414/788

(57) ABSTRACT

An apparatus and a process for the automatic palletising and/or depalletising of containers, in particular small-load carriers, having a control device are described. The control device is functionally connected to at least one sensor device for detecting the position and/or the orientation of at least one container to be gripped and to a gripping device for gripping the container. The gripping device has at least one outer gripper movable relative to the container for gripping at least one edge of the container. The outer gripper has at least two gripping jaws.

### RELATED APPLICATIONS

The present invention claims the benefit of the filing date of German Patent Application, Serial No. 10 2006 018 502.1, filed Apr. 21, 2006; the content of which is incorporated by reference herein.

### TECHNICAL FIELD

The present invention relates to an apparatus for the automatic palletising and/or depalletising of containers, in particular small-load carriers, having a control device which is functionally connected to at least one sensor device for detecting the position and/or the orientation of at least one container to be gripped and to a gripping device for gripping the container.

In addition, the invention relates to a process for the automatic palletising and/or depalletising of containers, in particular small-load carriers, in which the position and/or the orientation of at least one container to be gripped is detected and the container is gripped in dependence on this.

### BACKGROUND OF THE INVENTION

In production plants of the automotive industry in particular, small parts are transported from a storage location to a workstation in preferably standardised small-load carriers (SLC) which are frequently of different sizes. For the transportation, it is necessary to stack the small-load carriers on pallets at a palletising station (palletising) and to transport the pallets to a depalletising apparatus. The depalletising apparatus lifts the small-load carriers from the pallets and places them in particular on a conveyor belt (depalletising), by which they are conveyed to the appropriate workstation.

Apparatuses for automatic palletising or depalletising are known from the market. Robots employed for this purpose have gripping arms which engage in specially formed gripping hollows at the vertical edges of the small-load carriers and spread out there to produce the gripping force required to lift the small-load carriers.

The position of the gripping hollows relative to the pallet and generally in space varies particularly in the case of an arrangement of different-sized small-load carriers. It is therefore necessary to precisely determine the position of the small-load carrier to be gripped, in particular of its gripping hollows, before each gripping operation and to control the robot accordingly. The gripping hollows are relatively small; at present, complex sensor devices, in particular with a large number of CCD cameras, scanning units and tactile sensors, are therefore required to determine their position.

Other kinds of known relatively quick depalletising apparatuses are suitable only for container stacks. In these, the containers must be ready in the form of chimney stacks and are thus unsuitable for automatic transportation on pallets.

The present invention is provided to address these and other concerns.

### SUMMARY OF THE INVENTION

The object of the present invention is to design an apparatus and a method of the type mentioned at the beginning such that it is also possible for containers which have different sizes and vary in their position and orientation to be automatically palletised and/or depalletised with stacking and positional tolerances in a simple manner, in particular with as little sensor complexity as possible, and reliably.

This object can be achieved according to the invention in that the gripping device has at least one outer gripper movable relative to the container for gripping at least one edge of the container, and the outer gripper has at least two gripping jaws.

In the context of the invention, the edge of the container is understood to mean the upper edge region, freely accessible from above, of a side wall of the container, in particular the stacking edge provided with a step.

According to the present invention, the containers are thus not gripped in the gripping hollows, but by the at least one outer gripper from outside at their edge. For this purpose, outer grippers which allow a relatively large gripping-jaw spacing may be employed. In this way, the containers can also be grasped when the widely opened outer gripper is positioned relatively imprecisely above the edge to be gripped. The exact position and orientation of the container, in particular of its edge, does not have to be known. For a rough determination of the location and/or position, a relatively simple sensor device suffices. In particular, no complex image processing is required as in the prior art, where, with a plurality of sensor devices, a zero balance is required for each one. It is further advantageous that the container can also be gripped at an edge when only one or two container walls are freely accessible and grippable. The apparatus also enables fully automatic palletising or depalletising of containers which are otherwise not suitable for automatic handling, since, for example, they have no gripping hollows or the latter are covered or defective. It is thus possible to use both standardised and non-standardised containers. Owing to its mobility, the outer gripper can be adjusted to the size of the container, so that different-sized containers can be palletised or depalletised.

Expediently, the outer gripper may be a double gripper or a triple gripper. The double gripper can be used to grip an edge of a longitudinal side or a transverse side. The triple gripper allows the gripping of a longitudinal side and a transverse side, in particular in the region of a corner of the container.

In order to be able to adjust the gripping device to different container sizes in a simple manner and grip the container securely, the gripping device may have at least three outer grippers, at least two outer grippers being movable by motor in particular proportionally to one another.

Furthermore, an additional outer gripper (opposed gripper) may be at least vertically movable. It can thus be lowered as required, in order to grip a side wall, in particular a longitudinal side wall, of the container, which wall is in particular opposite one of the other outer grippers.

Expediently, the outer gripper may be pneumatically actuable, thereby enabling quick gripping of the edge.

The outer gripper may additionally have a safeguard to prevent the gripped container from slipping out.

Moreover, the outer gripper may have at least one initiator which detects when the gripping jaws of the outer gripper on the edge of the container have closed.

Furthermore, the gripping jaws may have exchangeable gripping plates. These can be exchanged quickly and simply, particularly in the event of wear.

In a further particularly advantageous embodiment, the sensor device may have a laser measuring system, in particular a laser scanner, which simply and quickly detects the position, orientation, size and/or type of the container. Moreover, this also enables determination of a setting pattern which characterises the arrangement also of different containers on the pallet. Particularly suitable for this is a laser scanner, by which the uppermost layer of the pallet can be scanned and the setting pattern can be ascertained by the control device via time-of-flight measurements. The setting pattern is then used to control the gripping device during the depalletising or palletising.

Expediently, the sensor device and the gripping device may be arranged on a gripping head, in particular of a robot. The placement of the sensor device fixedly on the gripping head spatially next to the gripping device has the great advantage that the recognition tolerances can be markedly improved by a constant distance between the sensor device and the uppermost layer of containers during movement of the gripping head to detect the container, since a desired distance is always maintained by the robot. Moreover, no separate sensor axis is required, thereby reducing the outlay, in particular the outlay on parts, the outlay on control, assembly and putting into operation. Furthermore, no complex and difficult-to-learn reference markings are required and no reference journeys between the robot and the sensor device are required, since the sensor coordinates can be directly assigned to the coordinates of the gripping device. Since the risk of collision is eliminated by the sensor device, the freedom of movement of the robot is also markedly increased.

The process according to the present invention is distinguished in that at least one outer gripper of the gripping device is moved relative to the container and with at least two gripping jaws grips at least one edge of the container. In this way, position-tolerant gripping of the container is possible, without complex position determination having to be performed beforehand.

The position and/or orientation of the container may expediently be optically detected here, in particular the container may be scanned by a laser by time-of-flight measurements, whereupon the outer gripper may be moved to the edge of the container, in such a way that at least two of the gripping jaws are positioned on both sides of the edge and subsequently at least one of the gripping jaws is guided towards the second, so that the edge is clamped between the two gripping jaws.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

The invention is explained in greater detail below by means of exemplary embodiments with reference to drawings in which:

FIG. 1 schematically shows the plan view of a depalletising station with a robot having a gripping head;

FIG. 2 schematically shows a side view of the depalletising station from FIG. 1 in the region of the robot, seen here opposite the conveying direction of the pallets to be unloaded;

FIG. 3 schematically shows another side view of the depalletising station from FIG. 1 in the region of the robot, seen here perpendicularly to the conveying direction of the pallets to be unloaded;

FIG. 4 schematically shows the gripping head from FIG. 1 in the longitudinal-side view, here with a gripped small-load carrier;

FIG. 5 schematically shows the gripping head from FIG. 1 in the bottom view;

FIG. 6 schematically shows the gripping head from FIG. 1 in the transverse-side, partially broken-open view with open outer grippers above a small-load carriers; and,

FIG. 7 schematically shows the gripping head from FIG. 6 with closed outer grippers.

### DETAILED DESCRIPTION OF THE INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

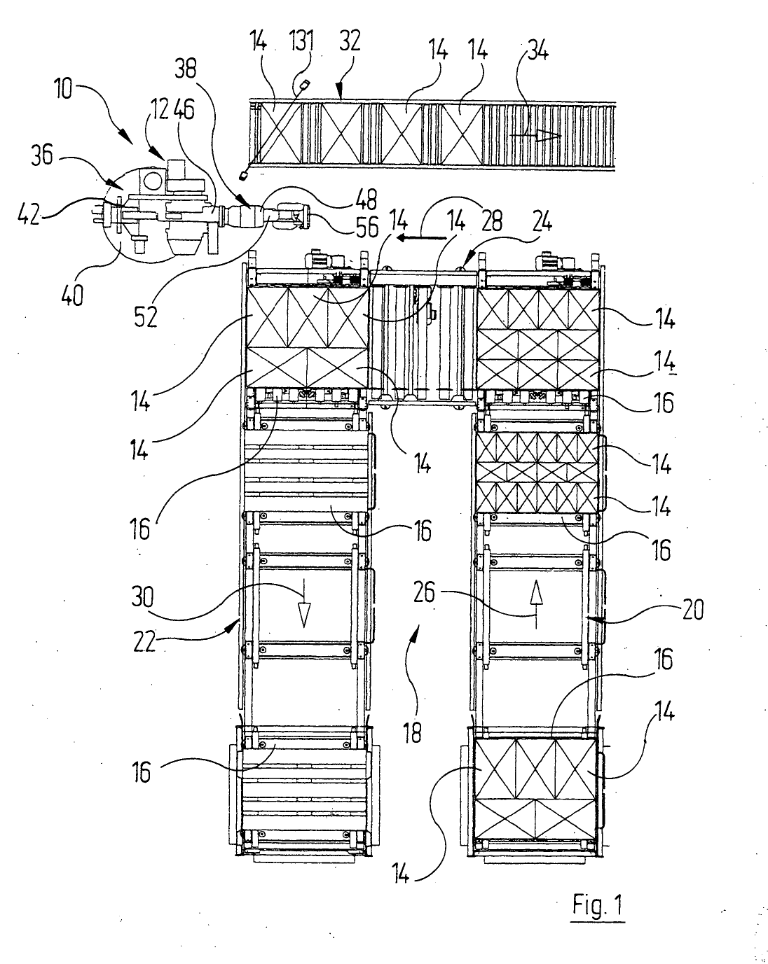

FIG. 1 illustrates in plan view a depalletising station, provided as a whole with the reference symbol 10, with a depalletising apparatus 12 for automatically depalletising small-load carriers 14 of different sizes.

The small-load carriers 14 are stacked on pallets 16.

The pallets 16 may be steel pallets, Europallets and/or Europallets on steel pallets.

The depalletising station 10 has a conveyor 18 with three conveyor belt regions 20, 22 and 24 arranged in a U-shape. The limb, on the right in FIG. 1, of the conveyor 18 is formed by the straight supply conveyor belt region 20 coming from below and the left limb is formed by the straight discharge conveyor belt region 22 leading downwards. The supply conveyor belt region 20 and the discharge conveyor belt region 22 are connected to one another via the straight transfer conveyor belt region 24, running at the top in FIG. 1. The end region, adjoining the discharge conveyor belt region 22, of the transfer conveyor belt region 24 is situated within range of the depalletising apparatus 12.

The conveyor 18 and the depalletising apparatus 12 are functionally connected to a control device (not shown) of the depalletising station 10.

The pallets 16 loaded with small-load carriers 14 can be supplied via the supply conveyor belt region 20 to the transfer conveyor belt region 24 in the direction of a first arrow 26 (supply-conveying direction 26), from the bottom upwards in FIG. 1.

In the transfer conveyor belt region 24, the pallets 16 can be conveyed from the supply conveyor belt region 20 to the discharge conveyor belt region 22, from right to left in FIG. 1, in the direction of a second arrow 28 (transfer-conveying direction 28) and depalletised in the end region thereof by the depalletising apparatus 12.

The empty pallets 16 can be led away from the transfer conveyor belt region 24 via the discharge conveyor belt region 22 in the direction of a third arrow 30 (discharge-conveying direction 30), from the top downwards in FIG. 1, preferably to a pallet store (not shown).

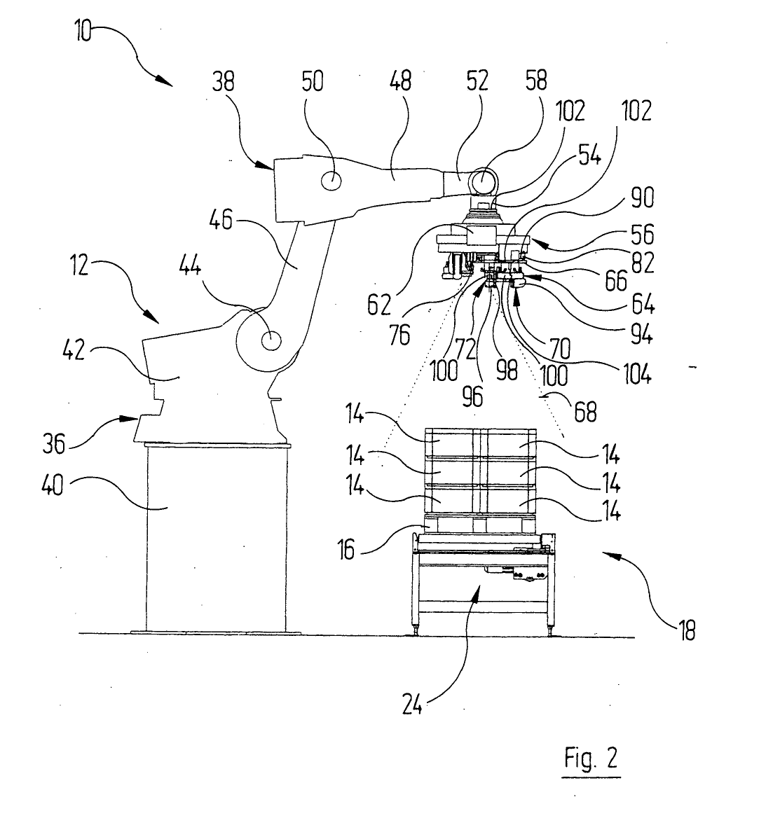

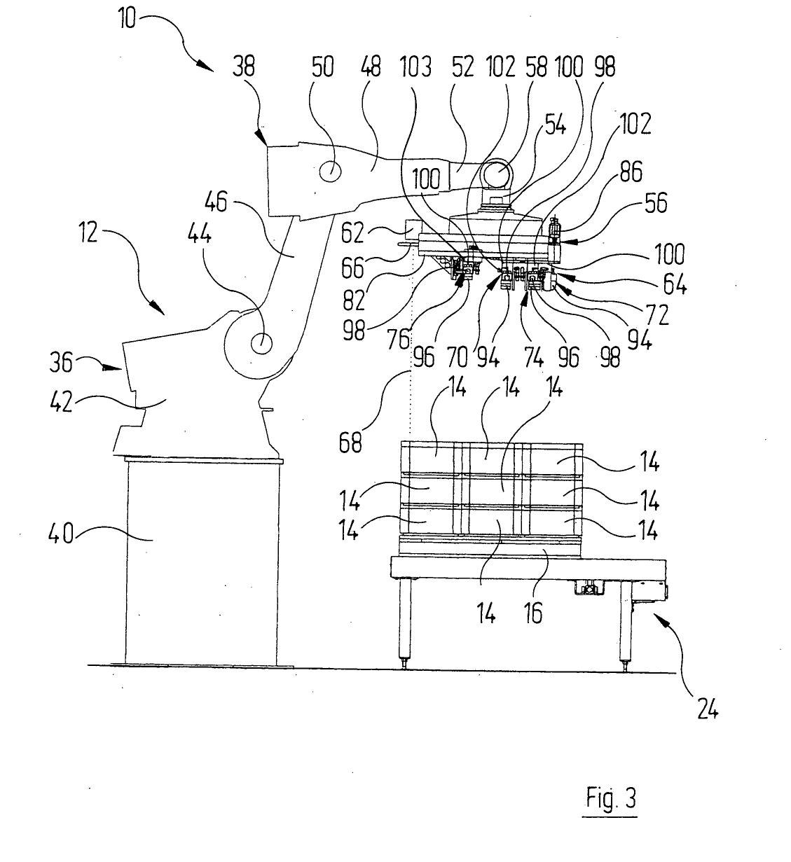

The supplied pallets 16 are loaded with small-load carriers 14 of different types, sizes, positions and orientations. Their uppermost layers thus have different setting patterns, seen from above. The small-load carriers 14 stand loosely on the pallets 16 and are thus undefined in their exact position. For example, situated in the uppermost layer on the pallet 16 which is ready for depalletising in the region of the depalletising apparatus 12, at the top left in FIG. 1, are a total of five cuboid-shaped small-load carriers 14 which are of the same size and open at the top. Three of them are oriented with their long side and two with their narrow side transversely with respect to transfer-conveying direction 28. A total of three identical layers are stacked on top of one another on this pallet 16 (FIGS. 2 and 3). The same arrangement is also found on the last pallet 16 in the supply conveyor belt region 20, at the bottom right. The uppermost layer of the second pallet 16 in the transfer conveyor belt region 24, at the top right, has ten identical, medium-sized small-load carriers 14, some of which are oriented with their long side and some with their narrow side transversely with respect to the transfer-conveying direction 28. A third pallet 16, which is situated, in the supply-conveying direction 26, behind the second, in FIG. 1 below the latter, has in the uppermost layer 16 equal-sized, small-load carriers 14 loaded in two different orientations.

Running parallel to the transfer conveyor belt region 24 at a distance from the latter is a conveyor belt 32 which leads from the depalletising apparatus 12 in the direction of a fourth arrow 34 (conveyor belt direction 34), towards the right in FIG. 1, to one or more workstation(s) (not shown). The depalletising apparatus 12 is placed such that it can lift the small-load carriers 14 from the pallets 16 onto the conveyor belt 32.

The depalletising apparatus 12 comprises a 6-axis industrial robot 36 with a gripping arm 38 and a gripping head 56. FIG. 1 shows the gripping arm 38 in its rest position between the transfer conveyor belt region 24 and the conveyor belt 32. FIGS. 2 and 3 illustrate the robot 36 in the respective side view in and perpendicular to the transfer-conveying direction 28. For the sake of simplicity, an isometric representation of the robot 36 has not been shown in FIGS. 2 and 3. Moreover, the supply conveyor belt region 20 and the discharge conveyor belt region 22 have not been shown there either.

The robot 36 stands on a pedestal 40, at the bottom left in FIGS. 2 and 3, which is arranged, in the transfer-conveying direction 28, behind the transfer conveyor belt region 24 (FIG. 1). A rotary body 42 is fastened on top of the pedestal 40 so as to be rotatable about a vertical first axis (not visible in the figures). The gripping arm 38 is fastened laterally to the rotary body 42, on the right in FIGS. 2 and 3, and facing the conveyor 18, so as to be vertically pivotable as a whole about a horizontal second axis 44. The gripping arm 38 is divided into two parts in the longitudinal direction. The two approximately equal-length gripping arm parts 46 and 48 are connected to one another so as to be pivotable relative to one another about a horizontal third axis 50 running parallel to the second axis 44. A free end region 52 of the gripping arm part 48 facing away from the rotary body 42 is rotatable about a fourth axis (not visible in the figures) which runs perpendicularly to the third axis 50 substantially in the longitudinal direction of the facing-away gripping arm part 48.

A flange 54 for the gripping head 56 is fastened to the free end region 52 of the gripping arm part 48. The flange 54 is pivotable about a fifth axis 58. The fifth axis 58 runs perpendicularly to the fourth axis. In the normal case, as illustrated in FIGS. 2 and 3, the fifth axis 58 runs horizontally parallel to the second axis 44 and to the third axis 50, perpendicularly to the vertical plane definable by the two gripping arm parts 46 and 48 pivoted with respect to one another.

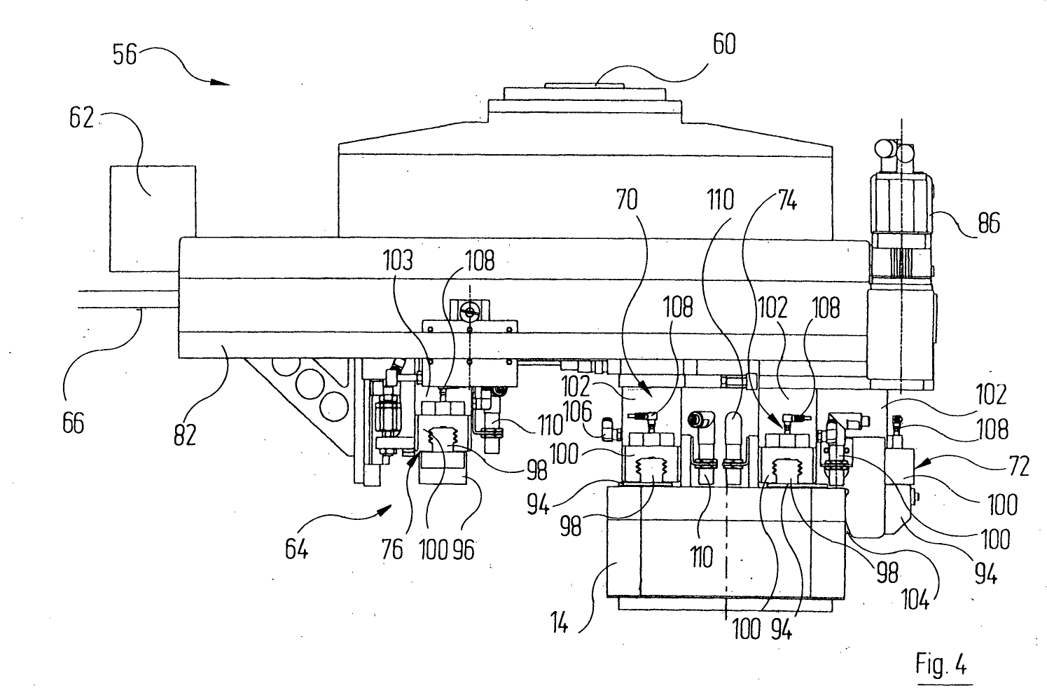

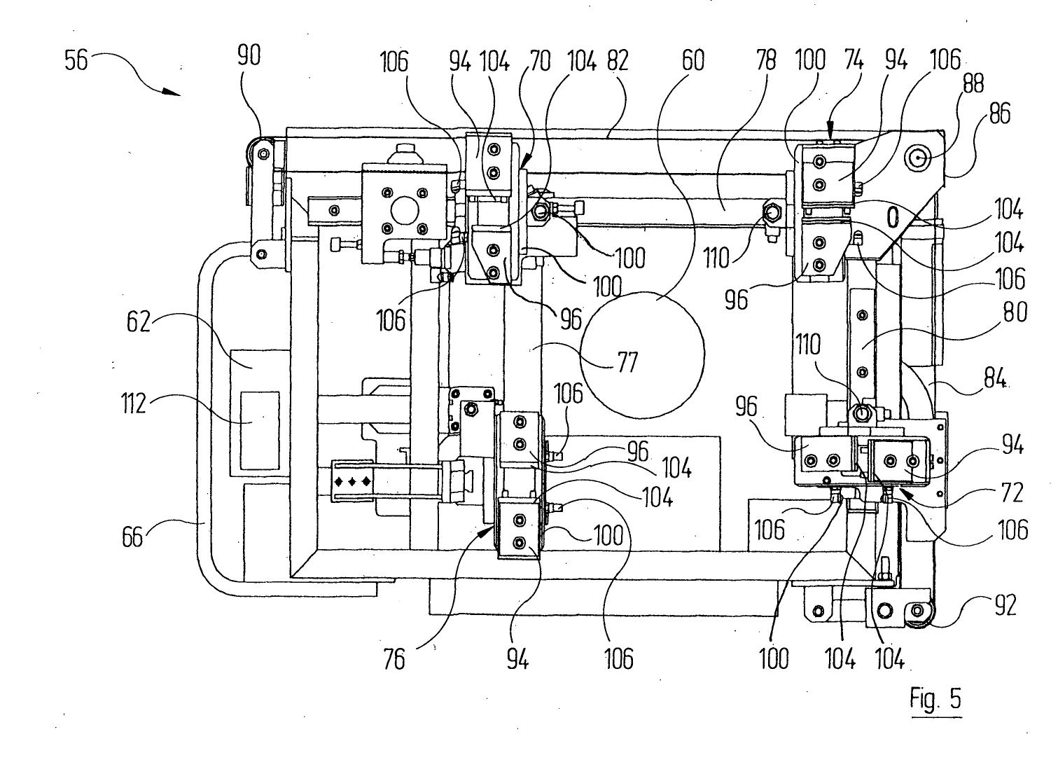

The gripping head 56 hangs on the flange 54. The gripping head 56 has a stable frame construction, rectangular in the bottom view in FIG. 5, preferably made of aluminium, by which it is fastened to the flange 54. It is rotatable about a sixth axis 60, visible in FIGS. 4 to 7, which runs perpendicularly to the fifth axis 58. In the normal case illustrated, the sixth axis 60 runs vertically, so that the gripping head 56 is rotatable in the horizontal.

The axes have the effect that the spatial position of the gripping head 56 can be changed without its orientation in space, in particular the vertical orientation of the sixth axis 60, i.e. its inclination, changing. In particular, by suitable rotations about the corresponding axes, the gripping head 56 can be moved in and opposite the transfer-conveying direction 28 without its horizontal orientation being changed. In its starting position, the gripping arm 38 is oriented such that the gripping head 56 is positioned, with a preset maximum stack height, at a safe distance from the uppermost layer of small-load carriers 14 and the pallet 16 can be moved unimpeded into the region of the robot 36.

Furthermore, the gripping head 56 is designed such that it can tilt to a certain extent. It can thus compensate for skew positions of a small-load carrier 14 when the latter lies, on one side, with the step of its stacking edge on the upper edge of a neighbouring small-load carrier 14.

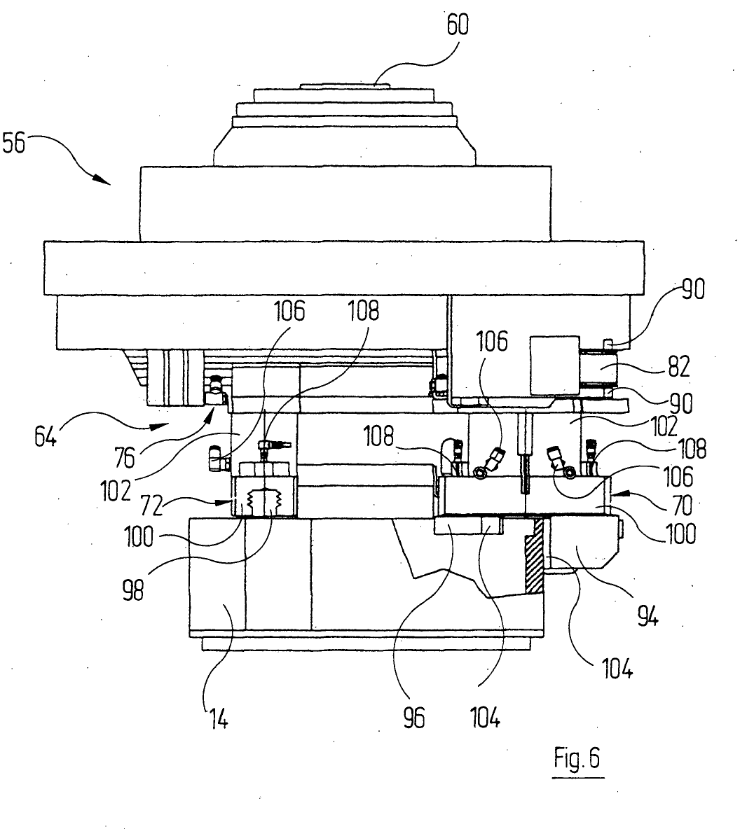

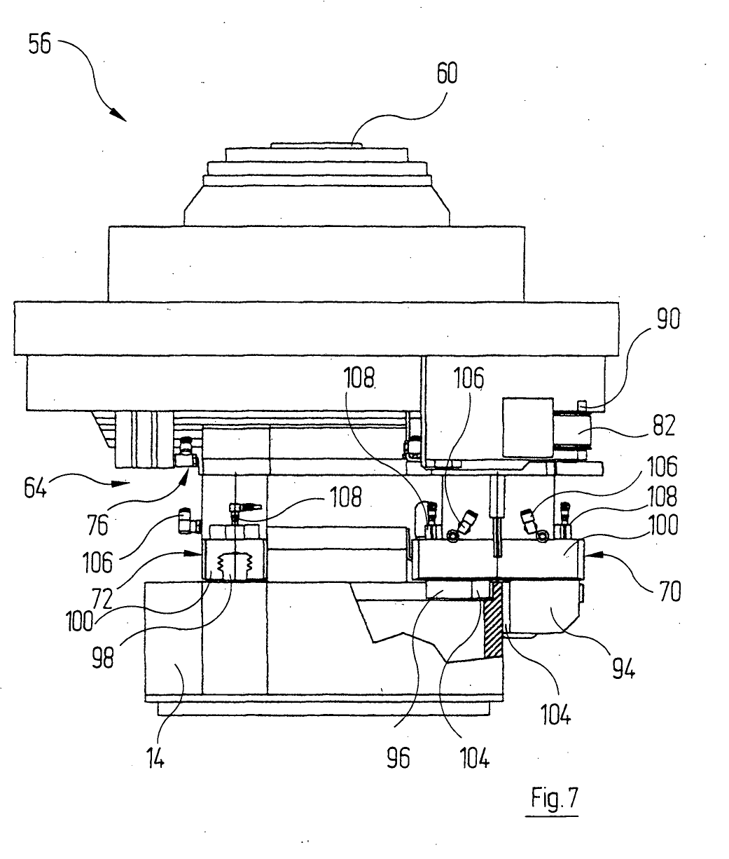

The gripping head 56, which is illustrated in detail in FIGS. 4 to 7 in a longitudinal-side, bottom-side and transverse-side view, respectively, comprises a laser scanner 62 and a gripping device 64; both are visible in FIGS. 2 to 5. For the sake of clarity, the laser scanner 62 is not shown in FIGS. 6 and 7.

The laser scanner 62 is situated on the outside of the transverse side, at the rear in the transfer-conveying direction 28, of the gripping head 56, pointing forwards in FIG. 2 and towards the left in FIGS. 3 to 5. Arranged below it is a guard bow 66, visible in FIGS. 3 to 5, which projects beyond it in the horizontal direction. The laser scanner 62 serves to detect the type, size, height, positions and orientation of the small-load carriers 14, i.e. the setting pattern and height position of the uppermost layer of the small-load carriers 14 on the pallet 16 to be unloaded. For this purpose, the laser scanner 62 performs a fan-like scanning movement perpendicularly to the movement direction of the gripping head 56. The wavelength of the laser lies in the visible wavelength range. The laser beam 68 is designed such that it is harmless to a human eye even when looking directly into the laser beam 68 (laser class 2). The laser beam 68 is fanned out in the transverse direction of the gripping head 56, i.e. transversely with respect to the transfer-conveying direction 28, to such a degree that it covers the entire pallet width (FIG. 2), even with the preset maximum stack height, also at the height of the edges of the uppermost layer of small-load carriers 14. The limits of the region scanned in fan-like manner are indicated by dotted lines in FIGS. 2 and 3. Through movement of the gripping head 56 by the gripping arm 38 opposite the transfer-conveying direction 28 along the pallet 16, the uppermost layer of small-load carriers 14 on the pallet 16 is scanned. During this the laser scanner 62 is moved, in the transfer-conveying direction 28, approximately centrally above the pallet 16. With the aid of time-of-flight measurements, the control device can determine the setting pattern and the height position of the uppermost layer of small-load carriers 14 using a suitable program routine.

The laser scanner 62 and the robot 36 are functionally connected to the control device in order to transfer the data acquired by the laser scanner 62 and to control the laser scanner 62 and the robot 36. Between the laser scanner 62, the robot 36 and the control device a protocol is agreed for data transfer and process control, in particular for a start and stop trigger for the scanning process and the robot movements and for outputting error messages.

The gripping device 64 is arranged on the bottom side of the gripping head 56. The small-load carriers 14 can be grasped on the pallets 16 by the gripping device 64, lifted by the gripping head 56 and, after suitable rotation of the rotary body 42 about the first axis, placed on the conveyor belt 32 by the gripping arm 38.

The gripping device 64 has (visible in particular in the bottom view in FIG. 5) four outer grippers 70, 72, 74 and 76, movable relative to the small-load carriers 14, each for gripping an edge of the respective small-load carrier 14. The movement of the outer grippers 70, 72, 74 and 76 takes place here by moving the gripping head 56 and/or, merely in the case of the outer grippers 70, 72, 76, by displacement relative to the gripping head 56.

An outer gripper displaceable on the longitudinal side (“longitudinal-side outer gripper” 70) is fastened so as to be displaceable, in FIG. 5 at the top horizontally, on a straight longitudinal guide rail 78. The longitudinal-side outer gripper 70 is shown at the top left in FIG. 5 and in a different position displaced towards the right in FIG. 4.

An outer gripper displaceable on the transverse side (“transverse-side outer gripper” 72) is fastened so as to be displaceable, in FIG. 5 on the right vertically, on a straight transverse guide rail 80. The transverse-side outer gripper 72) is shown at the bottom right in FIGS. 4 and 5.

The longitudinal guide rail 78 and the transverse guide rail 80 run at right angles to one another and are horizontally oriented in the case of normal orientation of the gripping head 56, as illustrated in FIGS. 2, 3, 4, 6 and 7.

The transverse guide rail 80 is situated on the side of the gripping head 56 opposite the laser scanner 62.

The longitudinal-side outer gripper 70 and the transverse-side outer gripper 72 are movable proportionally to one another along the corresponding guide rail 78 and 80, respectively, by a servo motor 86 via an in each case endless longitudinal-side drive belt 82 and transverse-side drive belt 84, respectively, and in this way can be set with variable gripping distances for different-sized small-load carriers 14. The servo motor 86 is controllably connected to the control device.

The servo motor 86 is arranged on the transverse side opposite the laser scanner 62 at the corner of the gripping head 56 adjacent to the geometrical point of intersection of the two guide rails 78 and 80, above the gripping device 64 in the longitudinal-side view in FIG. 4. Its drive axis 88, visible in FIG. 5, runs perpendicularly to the longitudinal guide rail 78 and to the transverse guide rail 80.

The longitudinal-side drive belt 82 runs outside the region defined by the four outer grippers 70, 72, 74 and 76, parallel to the longitudinal guide rail 78. It is guided on the transverse side of the gripping head 56 opposite the servo motor 86 via a longitudinal-side deflection roller 90, visible in FIGS. 2, 6 and 7, which is situated in the corner region of the gripping head 56.

The transverse-side drive belt 84 runs, correspondingly, parallel to the transverse guide rail 80. A transverse-side deflection roller 92, which is visible in FIG. 5, is situated in the corner region of the gripping head 56 diametrically opposite the longitudinal-side deflection roller 90.

When viewed laterally, the longitudinal-side drive belt 82 is arranged lower than the transverse-side drive belt 84, but this is not visible in the figures.

A fixed outer gripper 74, at the top right in FIG. 5, is stationary, i.e. not movable relative to the gripping head 56 in the plane, horizontal in the normal case, defined by the longitudinal guide rail 78 and the transverse guide rail 80.

A longitudinal-side opposed gripper 76, at the bottom left in FIG. 5, is fastened to the bottom of a carrier body 103, visible in FIGS. 3 and 4, which is adjustable via a lifting and lowering device (not visible in the figures) in its distance from the bottom side of the gripping head 56, vertically in the normal position of the gripping head 56.

The lifting and lowering device is connected to the longitudinal-side outer gripper 70 via a connecting strut 77, visible in FIG. 5, running perpendicularly to the longitudinal-side guide rail 78, and is movable jointly with this gripper at a fixed distance parallel to the longitudinal-side guide rail 78. The lifting and lowering device and with it the longitudinal-side opposed gripper 76 is guided during this on an opposed-gripper guide rail, not visible in FIG. 5, which runs parallel to the longitudinal-side guide rail 78.

The lifting and lowering device is controllably connected to the control device. As long as the opposed gripper 76 is not required, for example when a small small-load carrier 14 is to be gripped, it is arranged in its rest position, illustrated in FIGS. 2 to 4, 6 and 7, so far above the other outer grippers 70, 72 and 74 that, for example, it does not touch and thus does not disturb the edge of a neighbouring small-load carrier 14 to be gripped. As soon as it is required for gripping a large small-load carrier 14 for example, it can be lowered by the lifting and lowering device vertically to the height of the other outer grippers 70, 72 and 74, so that it can grip a corresponding edge.

All four outer grippers 70, 72, 74 and 76 are double grippers, that is to say they each have an outer gripping jaw 94 and an inner gripping jaw 96 which form a pair of gripping pincers open towards the small-load carriers 14, i.e. downwards in the normal case. The gripping jaws 94 and 96 have mutually parallel vertical gripping surfaces on their surface facing the respective other gripping jaw 96 and 94. The gripping jaws 94 and 96 are each fastened on a slide 98 visible in FIGS. 2, 3, 4, 6 and 7. The slides 98 can be guided in a respective linear guide 100 towards one another for gripping and away from one another for loosening the grip. The outer grippers 70, 72, 74 and 76 can thus also be set for edges of the small-load carriers 14 of different thicknesses.

The linear guides 100 of the transverse-side outer gripper 72, of the longitudinal-side outer gripper 70 and of the fixed outer gripper 74, and thus also the outer grippers 70, 72 and 74 themselves, are situated, in side view, at the same height at a fixed distance from the bottom side of the gripping head 56, in each case on the lower end face, facing away from the gripping head 56, of a respective approximately cuboid-shaped base body 102.

The linear guide 100 of the longitudinal-side opposed gripper 76 is situated below the carrier body 103 and is movable vertically with the latter.

The linear guides 100 of the longitudinal-side outer gripper 70, of the longitudinal-side opposed gripper 76 and of the fixed outer gripper 74 run in the transverse direction of the gripping head 56, i.e. parallel to the transverse guide rail 80. These outer grippers 70, 74 and 76 can grip the edges of a small-load carrier 14 which extend in the longitudinal direction of the gripping head 56, i.e. in the transfer-conveying direction 28.

The linear guide 100 of the transverse-side outer gripper 72 runs perpendicularly thereto in the longitudinal direction (FIGS. 6 and 7), so that the transverse-side outer gripper 72 can grip one of the edges in the transverse direction, i.e. transversely with respect to the transfer conveying direction 28.

The outer gripping jaws 94 are arranged, in the bottom view in FIG. 5, on the side of the respective outer gripper 70, 72, 74 and 76 facing the nearest outer side of the gripping head 56, while the inner gripping jaws 96 are arranged on the side facing the centre of the gripping head 56. In this way, the outer gripping jaws 94 can grasp the respective edges from outside the small-load carriers 14 and the inner gripping jaws 96 can grasp the edges from inside small-load carriers 14.

The corresponding dimension of the gripping jaws 96 corresponds to the distance between the upper edge and the lower step-shaped termination of the stacking edge of a standardised small-load carrier 14; this is visible in FIGS. 6 and 7, which show the gripped small-load carrier 14 in the region of the outer gripper 70 in partial section. This has the advantage that the inner gripping jaws 96 are not impeded by objects in the small-load carriers 14, i.e. the small-load carriers 14 can be loaded up to the height of the lower step-shaped termination of the stacking edge. The vertical extent of the outer gripping jaws 94 is markedly greater than that of the inner gripping jaws 96, enabling them to bear securely and stably against horizontal stiffeners, which are usually situated on the outside of the edges of the small-load carriers 14.

The gripping jaws 94 and 96 furthermore have an exchangeable gripping plate 104 on each of their gripping surfaces.

All the outer grippers 70, 72, 74 and 76 are pneumatically actuable, that is to say the slides 98 and hence the gripping jaws 94 and 96 can, in a manner known per se, via compressed air be pushed towards one another for gripping and held in this manner. In the pressure-free state, the gripping jaw pairs 94, 96 are each pushed apart by a compression spring (not shown). Each outer gripper 70, 72, 74 and 76 has, on the linear guides 100 for each of the gripping jaws 94 and 96, a pneumatic connection 106 for closing the grip. For the sake of clarity, the pneumatic connections 106 have been provided with reference symbols merely in FIGS. 4, 5, 6 and 7. The pneumatic connections 106 are connected to a compressed-air device via compressed-air hoses (not illustrated) and can be separately supplied with compressed air. The compressed-air device is controllably connected to the control device.

Furthermore, each outer gripper 70, 72, 74 and 76 has an initiator 108, shown in FIGS. 4, 6 and 7, by which a signal is produced as soon as the gripping jaw pairs 94, 96 are closed, whereupon further introduction of compressed-air is stopped. The initiators 108 can produce the signal, for example, in dependence on the pressure of the compressed air at the gripping jaws 94 and 96. The initiators 108 are connected to the control device of the depalletising apparatus 12 via signal lines (not shown).

In addition, all the outer grippers 70, 72, 74 and 76 have in each case a sensor 110, visible in FIGS. 4 and 5, for producing a signal as soon as the corresponding outer gripper 70, 72, 74 and 76 is at a vertical distance, suitable for gripping, from the edge to be gripped by it. The sensors 110 are each situated to the side of the gripping jaws 94, 96 in the plane of contact of these jaws when in the closed state. In side view, they are mounted approximately at the height of the slides 98 of the gripping jaws 94, 96, so that they do not impede the gripping, and in a downwardly directed manner. With the sensors 110 it is thus possible to detect when the edge to be gripped is situated at the correct distance between the gripping jaws 94, 96.

For depalletising a loaded pallet 16, the latter is firstly conveyed by the conveyor 18 to the depalletising apparatus 12 and placed in readiness there, for example with a tolerance of ±100 mm, in a region, which can be reached by the gripping head 56, at the end of the transfer conveyor belt region 24 (FIGS. 1 to 3). The conveyor 18 is operated here cyclically, in such a way that as soon as one pallet 16 has been unloaded, the next loaded pallet 16 is conveyed to the depalletising apparatus 12.

As soon as the pallet 16 is situated at the end of the transfer conveyor belt region 24, i.e. the sight of the laser scanner 62 can no longer be obstructed by any previous pallet 16, a routine for determining the setting pattern of the uppermost layer of small-load carriers 14 is started. For this purpose, the gripping head 56 is firstly positioned by the robot 36 above the pallet 16 such that its longitudinal direction runs parallel to the transfer-conveying direction 28. The gripping head 56 is oriented here such that the laser scanner 62 is situated, viewed in the transfer-conveying direction 28, approximately centrally above the pallet 16 (FIG. 2) and, viewed perpendicularly to the transfer-conveying direction 28, at the height of the edge, facing the depalletising apparatus 12, of the uppermost layer (FIG. 3). The distance of an exit window 112, visible in FIG. 5, of the laser scanner 62 from the uppermost layer is, for example, between 900 mm and 1700 mm here. The laser beam 68 which scans in fan-like manner then covers the entire width of the uppermost layer.

Subsequently, the gripping head 56 is moved opposite the transfer-conveying direction 28 at a constant speed horizontally above the pallet 16 without otherwise changing its orientation in space. During this, the uppermost layer of the small-load carriers 14 is continuously scanned by the laser scanner 62 in individual scanning slices (sectors). A three-dimensional surface profile of the load (setting pattern) is then calculated from the data thus acquired and is supplied to the control device. The control device uses an object recognition routine to detect from the setting pattern whether, which and at what position on the pallet 16 small-load carriers 14 are ready for gripping, in particular where and in what way their edges are running. If small-load carriers 14 are present, the data relevant to gripping, in particular their spatial position and their orientation, in particular their angles of rotation, relative to a coordinate system of the robot 36 are determined.

If defective small-load carriers 14 are detected during the scanning, provision may be made to output a fault message to an output unit (not illustrated) and to stop the depalletising process. After removing the defective small-load carrier 14, the process can be continued, in particular with renewed scanning of the uppermost layer.

It is also possible to detect that the small-load carriers 14 cannot be gripped and transmit this to the control device via an interface. For example, provision may be made to output an error message when parts of the load in the small-load carriers 14 are detected along the gripping positions which interfere with or even prevent their ability to be gripped. The fault can then be manually or automatically corrected. To restart the automatic depalletising process, the pallet 16 can be re-scanned to detect the setting pattern after the fault-clearing measures.

When all the data relevant to gripping is available, the robot 36 moves the gripping head 56 over the small-load carrier 14 to be gripped, at least two of the four side walls of which are free, i.e. grippable. Preferably, this is a small-load carrier 14 at the edge of the uppermost layer.

The gripping head 56 is arranged here such that the fixed outer gripper 74 is positioned in the corner region of a freely accessible side wall of the small-load carrier 14. The longitudinal-side outer gripper 70 and the transverse-side outer gripper 72, driven by the servo motor 86 with the corresponding drive belts 82 and 84 respectively, are moved relative to the small-load carrier 14, along the longitudinal guide rail 78 and the transverse guide rail 80 respectively, into their respective position for gripping the corresponding edge of the small-load carrier 14.

As soon as the sensors 110 detect that the outer grippers 70, 72 and 74 are in their gripping position, i.e. the respective gripping jaws 94 and 96 are positioned at the suitable distance in pairs on both sides of the respective edge, the corresponding pneumatic connections 106 for closing the outer grippers 70, 72 and 74 are supplied with compressed air and the fixed outer gripper 74, the longitudinal-side outer gripper 70 and the transverse-side outer gripper 72 are closed. The corresponding edges are then firmly clamped between the gripping jaws 94 and 96. A corresponding signal is produced by the initiators 108 and supplied to the control device.

The small-load carrier 14 now gripped at two side walls by three outer grippers 70, 72 and 74 is lifted by the height of the stacking edge, for example by about 20 mm, to enable the closure of the opposed gripper 76. In this process, the opposed gripper 76 is lowered by its lifting and lowering device to the height of the other outer grippers 70, 72 and 74, so that it can grip the edge corresponding to it analogously to the other outer grippers 70, 72 and 74. Its initiators 108 and sensors 110 transmit its correct position to the control device here.

For smaller small-load carriers 14 it is possible to do without the gripping of the opposed gripper 76. In this case, the opposed gripper 76 is not lowered.

The gripping head 56 with the small-load carrier 14 is now lifted further, so that the bottom of the latter is above the edges of the neighbouring small-load carriers 14, and the rotary body 42 with the gripping arm 38 is rotated horizontally until the gripping head 56 is positioned above the conveyor belt 32. During this, the longitudinal direction of the gripping head 56 is oriented in the conveyor belt direction 34. For this purpose, the gripping head 56 is correspondingly rotated by the flange 54 horizontally about the sixth axis.

The small-load carrier 14 is then deposited on the conveyor belt 32. This is detected by a light barrier 131 shown in FIG. 1. A light beam of the light barrier 131 runs, for this purpose, in the region of the conveyor belt 32 in which the small-load carrier 14 is to be deposited, horizontally obliquely over the conveyor belt 32 at a distance of about 20 cm therefrom. As soon as the lower edge of the small-load carrier 14 interrupts the light beam, the light barrier 131 transmits a corresponding signal to the control device, which then causes the small-load carrier 14 to be lowered by the remaining 20 cm. Irrespective of the height of the small-load carrier 14, the control unit thus ascertains when the bottom thereof comes down onto the conveyor belt 32. To make it easier to understand, the light beam of the light barrier 131 is shown continuously, even though it is interrupted by the small-load carrier 14 shown set down there on the conveyor belt.

The pressure to the pneumatic connections 106 is then switched off by the pressure device, in order to open the outer grippers 70, 72, 74 and 76.

Finally, the gripping head 56 is lifted by the gripping arm 38 and moved back to the pallet 16 again, in order to grip the next small-load carrier 14.

In this way, all the small-load carriers 14 of the uppermost layer are successively depalletised.

After that, the process is repeated, starting with the scanning process of the respectively next uppermost layer, until the pallet 16 is completely unloaded.

As soon as the pallet 16 is empty, it is conveyed in the next conveying cycle to the discharge conveyor belt region 22 and by the latter to the pallet store, and the next loaded pallet 16 is conveyed by the transfer conveyor belt region 24 to the depalletising apparatus 12, where it is unloaded as described above. At the same time, the following loaded pallets 16 are transported to the transfer conveyor belt region 24 by the supply conveyor belt region 20.

Tests have shown that the unloading of, for example, 10 small-load carriers 14 takes about 80 seconds in the practical exemplary embodiment. The entire depalletising process, including the scanning process and the evaluating and transmission time for the data, amounts to about 90 seconds. Allowing for conveying and changing times for pallets 16, it is thus possible to depalletise on average about 6 small-load carriers 14 per minute.

In the case of an alternative exemplary embodiment (not illustrated), the laser scanner 62 may be arranged separately from the gripping head 56 rather than on it and may be movable via its own sensor axis by a drive motor separately from the gripping head 56 to scan the pallet 16.

In this case, the coordinate system of the robot 36 can be aligned before the scanning process with a coordinate system of the laser scanner 62, for example using reference marks. The reference marks are preferably situated on the pallet 16. They define in each case master positions both for the robot 36 and for the laser scanner 62.

The spatial position and orientation of the small-load carrier 14 ascertained during scanning is then compared with one of the master positions situated in the vicinity of the current positional point of the small-load carrier 14. From the comparison, a positional correction with respect to the corresponding reference mark is calculated and communicated to the robot 36. In this way, a positional error of the gripping head 56 relative to the laser scanner 62 is partially compensated. A positional drift of the gripping head 56 can be determined by cyclic referencing. In the practical example, the coordinate systems of the laser scanner 62 and of the robot 36 may be coordinated with one another such that an accuracy of about ±2 mm can be achieved. In this way, it is possible to scan scanning fields with areas of about 1250 mm×850 mm and greater with the laser scanner 62 at a distance of about 900 mm from the uppermost pallet layer.

In all the exemplary embodiments described, all the faults which occur during the scanning process can be recorded and displayed by a memory and output unit (not shown), in particular a personal computer. In addition, the fault messages can be logged by date and time in a file on the memory and output unit. The picking-up of small-load carriers 14 which have not been identified by the laser scanner 62 can also be logged on the memory and storage unit by date, time and the reason for the non-identification.

The apparatus and the process may, with appropriate modification, also be used for palletising containers, in particular small-load carriers 14.

Instead of small-load carriers 14, other standardised or non-standardised containers having a grippable edge may also be palletised or depalletised.

The small-load carriers 14 on a pallet 16 may be identical or different. The setting patterns may be predefined.

Instead of ascertaining the setting pattern of all the small-load carriers 14, it is also possible to determine only the position and orientation of the respective small-load carrier 14 to be gripped.

Instead of pallets 16, other kinds of carrier devices may also be used.

A plurality of sensor devices, in particular laser scanners 62, may also be provided.

The gripping device 64 may also have only one outer gripper or more than four outer grippers 70, 72, 74 and 76. Outer grippers for optional retrofitting may also be provided.

Each of the outer grippers 70, 72, 74 and 76 may also be realised, not as double grippers, but as triple grippers with three gripping jaws 94, 96, by which two edges running perpendicularly to one another at a corner of the container can be gripped simultaneously.

Furthermore, one or more outer grippers 70, 72, 74 and 76 may have a gripping-force safeguard or a means for engaging underneath, which safeguard or means ensures that the gripped edges do not slip out.

The laser of the laser scanner 62 may also emit light in the non-visible wavelength range.

Instead of the laser scanner 62, there may also be provided another kind of sensor device, in particular optical, with which, for example, colours can also be detected.

The sensor device may also be designed such that it can detect the colour of the small-load carriers 14 as an additional identification feature.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. An apparatus for the automatic palletising and/or depalletising of containers, having a control device which is functionally connected to at least one sensor device for detecting the position and/or the orientation of at least one container to be gripped and to a gripping device for gripping the container, wherein the gripping device has at least one outer gripper movable relative to the container for gripping at least one edge of the container, and the outer gripper has at least two gripping jaws.

2. The apparatus of claim 1, wherein the at least one outer gripper is a double gripper or a triple gripper.

3. The apparatus of claim 1, wherein the gripping device has at least three outer grippers, wherein at least two outer grippers being movable by a motor.

4. The apparatus of claim 1, wherein the at least one additional outer gripper is at least vertically movable.

5. The apparatus of claim 1, wherein the at least one outer gripper is pneumatically actuable.

6. The apparatus of claim 1, wherein the at least one outer gripper includes a safeguard to prevent the gripped container from slipping out.

7. The apparatus of claim 1, wherein the at least one outer gripper includes at least one initiator that detects when the gripping jaws of the at least one outer gripper on the edge of the container has closed.

8. The apparatus of claim 1, wherein the at least two gripping jaws include exchangeable gripping plates.

9. The apparatus of claim 1, wherein the sensor device includes a laser measuring system, which detects the position, orientation, size and/or type of the container.

10. The apparatus of claim 9, wherein the laser measuring device is a laser scanner.

11. The apparatus of claim 1, wherein the sensor device and the gripping device are arranged on a gripping head.

12. The apparatus of claim 11, wherein the gripping head is operatively attached to a robot.

13. A process for the automatic palletising and/or depalletising of containers, in which the position and/or the orientation of at least one container to be gripped is detected and the container is gripped in dependence on this, wherein at least one outer gripper of the gripping device is moved relative to the container and with at least two gripping jaws grips at least one edge of the container.

14. The process of claim 13, wherein the position and/or the orientation of the container is optically detected, whereupon the outer gripper is moved to the edge of the container, in such a way that at least two of the gripping jaws are positioned on both sides of the edge and subsequently at least one of the gripping jaws is guided towards the second, so that the edge is clamped between the two gripping jaws.

15. The process of claim 14, further comprising utilizing a laser incorporating time-of-flight measurements to optically scan the position and/or the orientation of the container
